(19) United States
(12) Patent Application Publication
(10) Pub. No.: US 2017/0228696 A1
(43) Pub. Date: Aug. 10, 2017

(54) SYSTEM AND METHOD FOR DETERMINING JOB SIMILARITY USING A COLLATION OF CAREER STREAMS TO MATCH CANDIDATES TO A JOB

(71) Applicants: Oliver Brdiczka, San Jose, CA (US); Sunil Kochikar Pai, Houston, TX (US); Amrit Saxena, Scottsdale, AZ (US)

(72) Inventors: Oliver Brdiczka, San Jose, CA (US); Sunil Kochikar Pai, Houston, TX (US); Amrit Saxena, Scottsdale, AZ (US)

(73) Assignee: Stella.Ai, Inc., New York, NY (US)

(21) Appl. No.: 15/496,586

(22) Filed: Apr. 25, 2017

(51) Int. Cl. G06Q 10/10; G06F 17/30

(52) U.S. Cl. CPC G06Q 10/1053; G06F 17/30516; G06F 17/3053

(57) ABSTRACT

An improved system and method for matching candidates to a job using job similarity and candidate similarity is provided. A job model with clustered feature datasets may be generated from a corpus of candidate profiles, may be initialized by boosting clustered features weights, and may be iteratively tuned using feedback about the fit of candidates to the job model. A collation of career streams may be generated from a corpus of candidate profiles with a count of occurrences of each career stream within the corpus of candidate profiles. A job profile may be matched to candidate profiles either by determining candidate match scores between a job model of the job profile using clustered feature datasets or by determining job similarity scores between the job profile and jobs in the candidate profiles using career stream counts, or by determining both candidate match scores and job similarity scores.

### FIELD OF THE INVENTION

The invention relates generally to computer systems, and more particularly to an improved system and method for matching candidates to a job using job similarity and candidate similarity.

### BACKGROUND OF THE INVENTION

Conventional recruiting processes are very labor intensive and expensive. Recruiters frequently identify, locate, and source candidates for a job through manual searches online and in social networks. Corporate recruiters process candidate application information using commercially available applicant tracking systems which may be internally hosted or externally hosted by a third party. For each applicant, recruiters evaluate whether the applicant is a good fit for an open job, and, among other considerations, whether the current or previous job of the applicant might be related or similar to the open job. Some social networks may provide recruiting services for employers who use the service at best to match the employers' job profile to profiles of members of the social network to find members who may meet or exceed the requirements of the employers' job.

Such recruiting processes and recruiting services poorly match candidates to jobs because such systems are unable to reconcile variant company job level categorizations, dissonant job requirements and descriptions for comparable jobs, differing corporate soft skills, varying corporate cultural biases and inconsistent eligibility requirements. Such inadequate technological processes result in mismatches between candidates and jobs that lead to unexpected attrition rates and staffing costs.

What is needed are improved technological processes and a system that can discover the best candidates that are good fits for a particular job. Such technological processes and system should reconcile variant company job level categorizations, dissonant job requirements and descriptions for comparable jobs.

### SUMMARY OF THE INVENTION

Briefly, a system and method for matching candidates to a job using job similarity and candidate similarity is presented. In various embodiments, a recruiter client may be operably connected to a job server. The recruiter client may include a recruiting application having functionality for communicating with an online application on the job server. The recruiter client may communicate to a job server through a network, send a request to source candidates for a job description, and receive from the job server a short list of candidates matched for a job.

In various embodiments, the job server may support services for modeling jobs, may support services for data mining career streams of a corpus of candidate profiles, and may support services for matching candidates to a job using job similarity and candidate similarity. In particular, the job server may include a career path compiler that may include functionality for data mining a large corpus of candidate profiles to extract job transitions and construct a collation of career streams and career stream counts. The career path compiler may include a job information parser having functionality to parse elements of a candidate profile and extract information about job transitions such as a job title, job description, employer, service dates, preceding job information, subsequent job information, and so forth. And the career path compiler may include a career stream constructor having functionality to construct a collation of career streams and career stream counts from the information about job transitions extracted from the candidate profiles.

The job server may also include a job modeler in an embodiment that may include functionality for generating a job model with clustered feature datasets for a job profile and functionality for tuning the job model from feedback about the fit for candidates sourced for the job profile. In an embodiment, the job modeler may include a feature clustering engine having functionality for generating clustered feature datasets, a job model initializer having functionality for initializing feature weights and clustered feature weights and having functionality for boosting clustered feature weights, and a job model tuner having functionality for tuning the job model weights from feedback about the fit of candidates sourced for the job.

And the job server may include a job match engine having functionality in an embodiment for receiving a request to match candidate profiles to a job profile, and functionality for sending a list of one of more candidate profiles to a ranking engine to rank the candidate profiles matched to the job profile. In an embodiment, the job match engine may include a job similarity engine having functionality for determining job similarity scores between a job profile and one or more jobs in each of the candidate profiles using career stream counts of career streams. The job match engine may also include a job probability engine in an embodiment having functionality for determining candidate match scores between a job model of the job profile using clustered feature datasets and each of the candidate profiles. The system and method may match candidates to a job using either job similarity, candidate similarity, or both job similarity and candidate similarity.

In an embodiment, an online application on the job server such as the recruiter application may receive a request with a job profile from a recruiting application executing on a recruiter client to match candidates to the job profile. In various embodiments on a job server, job similarity scores may be determined between the job profile and one or more jobs in each candidate profile in a list of candidate profiles using career stream counts of career streams extracted from the large corpus of candidate profiles. And candidate match scores may be determined between a job model of the job profile using the clustered feature datasets and each candidate profile in a list of candidate profiles. A combined list of job similarity scores for candidate profiles and candidate match scores for candidate profiles that exceed a threshold may be ranked in an embodiment. A short list of ranked job matches with the highest scores among the job similarity scores and the candidate match scores may be saved in server storage and served to a recruiter client. And the recruiter client may provide feedback to the job server about the fit of candidates on the short list of ranked candidates.

Conveniently, the system and method may automatically discover candidate for a job using either job similarity, candidate similarity, or both job similarity and candidate similarity. Advantageously, the system and method may automatically identify whether the candidate's transition to the position of the job profile is a promotion or lateral move and whether the candidate's transition to the position of the job profile is a job transition to a similar job on a career path leading to the candidate's career objective. And the system and method may leverage candidate similarity to build a job model with clustered features, initialize the job model by boosting clustered features weights, and iteratively tune the job model using feedback about the fit of candidates to the job model.

Other advantages will become apparent from the following detailed description when taken in conjunction with the drawings, in which:

### BRIEF DESCRIPTION OF THE DRAWINGS

FIG. 1 is a block diagram generally representing a computer system as an illustrative example in an embodiment;

FIG. 2 is a block diagram generally representing an architecture of system components for matching candidates to a job using job similarity and candidate similarity, as an illustrative example in an embodiment;

FIG. 3 is a flowchart generally representing the steps undertaken in an embodiment for matching candidates to a job using job similarity and candidate similarity;

FIG. 4 is a flowchart generally representing the steps undertaken in an embodiment for generating a job model with clustered feature datasets for a job profile;

FIG. 5 is a flowchart generally representing the steps undertaken in an embodiment for generating clustered feature datasets for the job model from the corpus of candidate profiles;

FIG. 6 is a flowchart generally representing the steps undertaken in an embodiment for initializing job model weights for the job model with clustered feature datasets generated from the corpus of candidate profiles;

FIG. 7 is a flowchart generally representing the steps undertaken in an embodiment for tuning the job model weights for the job model with clustered feature datasets using feedback from sourcing candidate profiles for the job represented by the job model;

FIG. 8 is a flowchart generally representing the steps undertaken in an embodiment for generating a career stream collation of career streams with career stream counts from a large corpus of candidate profiles; and

FIG. 9 is a flowchart generally representing the steps undertaken in an embodiment for calculating the immediate transition ratios and the jaccard similarity coefficients between two work experiences to determine job similarity.

### DETAILED DESCRIPTION

### Exemplary Operating Environment

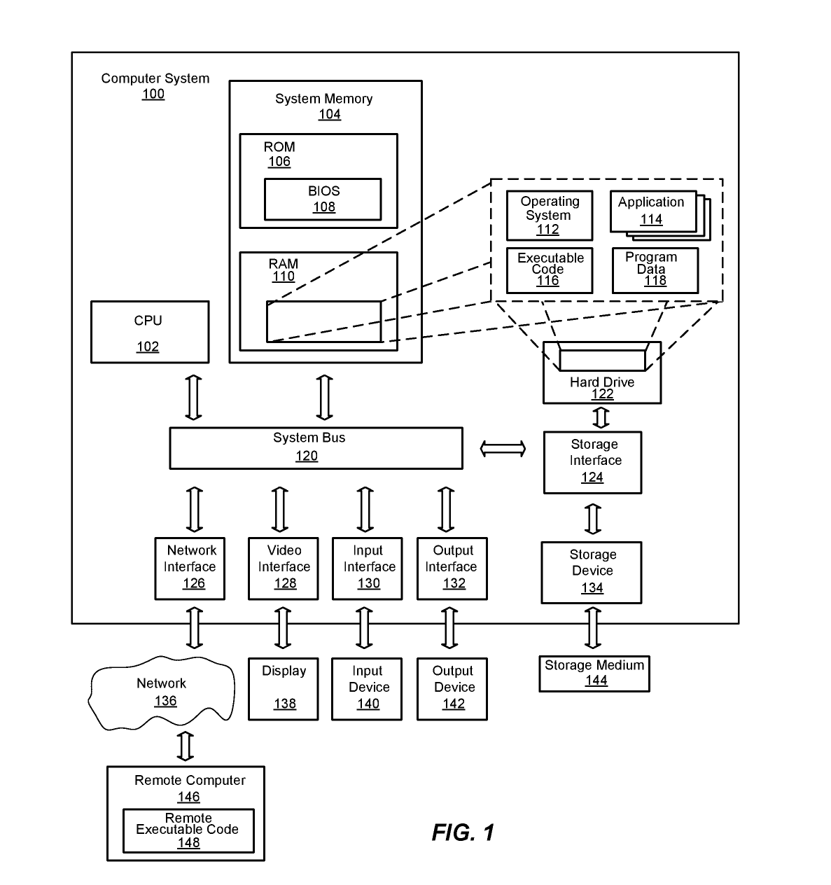

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be a solid-state drive that reads from or writes to non-removable, nonvolatile solid-state storage. Alternatively, storage device 134 may be a solid-state drive, an optical disk drive or a magnetic disk drive that reads from or writes to a removable, a nonvolatile storage medium 144 such as solid-state storage, an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Those skilled in the art will appreciate that the computer system 100 may also be implemented within a system-on-a-chip architecture including memory, external interfaces and an operating system.

### Matching Candidates to a Job Using Job Similarity and Candidate Similarity

A system and method is disclosed in various embodiments that are generally directed to matching candidates to a job using job similarity and candidate similarity. More particularly, the system and method disclosed may support services for modeling jobs, data mining career streams of a corpus of candidate profiles, and matching candidates to a job using job similarity and candidate similarity. As will be seen, by data mining a large corpus of candidate profiles to discover transitive steps between two work experiences, the system and method may automatically discover candidates for an open position where the job transition from their current position to the open position may be a promotion or lateral move and where the job may be similar to a job leading toward the career objective of the candidate. Furthermore, the system and method may leverage candidate similarity to build a job model with clustered features, initialize the job model by boosting clustered features weights, and iteratively tune the job model using feedback about the fit of candidates to the job model. As will be understood, the various block diagrams, flow charts and scenarios described herein are only examples, and there are many other scenarios to which the system and method disclosed will apply.

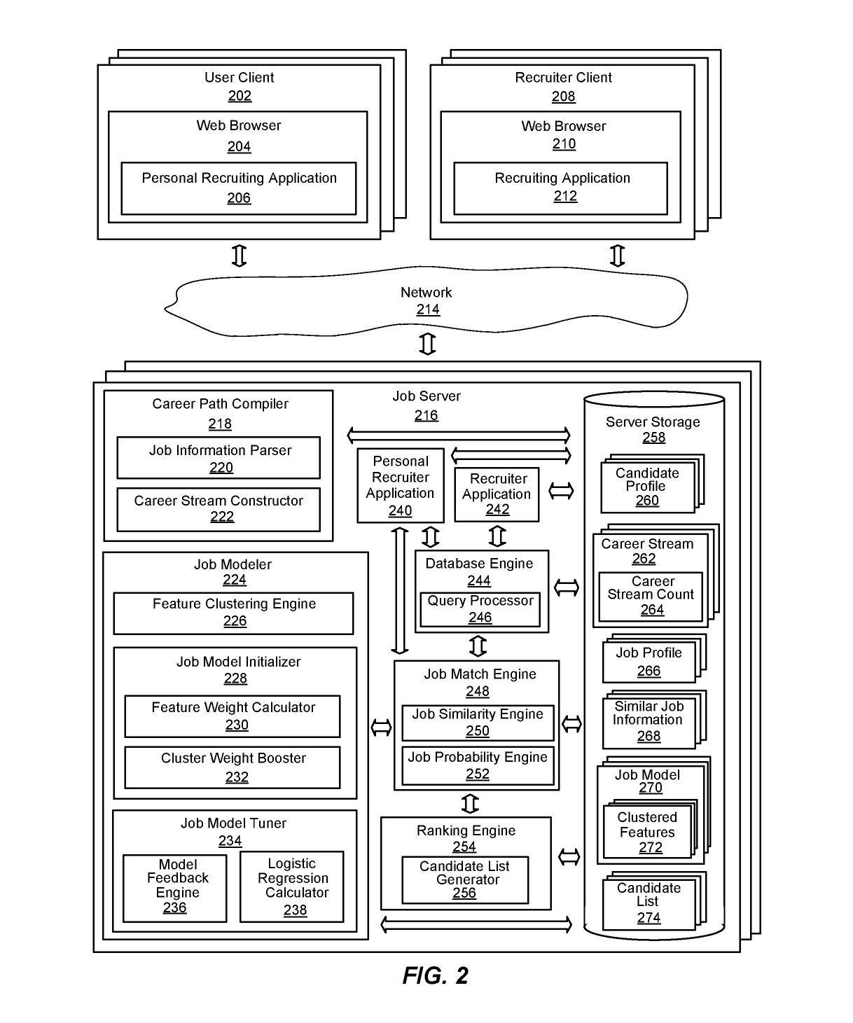

Turning to FIG. 2 of the drawings, there is shown a block diagram generally representing an architecture of system components in an embodiment for matching candidates to a job using job similarity and candidate similarity as an illustrative example. Those skilled in the art will appreciate that the functionality implemented within the blocks illustrated in the diagram may be implemented as separate components or the functionality of several or all of the blocks may be implemented within a single component. For example, the functionality for the personal recruiting application 206 on the user client 202 may be implemented as a separate component from the web browser 204, which may be the case for a mobile device such as a smartphone. Note that in an embodiment on a mobile device, the functionality of the personal recruiting application 206 may be implemented both within the web browser 204 as shown and as a separate component so that a mobile device user may use either the web browser 204 with the functionality of the personal recruiting application 206 included or the personal recruiting application 206 as a separate application component. As another example, the functionality of the job information parser 220 and the career stream constructor 222 may be implemented in an alternate embodiment within a single component. Moreover, those skilled in the art will appreciate that the functionality implemented within the blocks illustrated in the diagram may be executed on a single computer or distributed across a plurality of computers for execution. Furthermore, those skilled in the art may also appreciate that the functionality implemented within the blocks illustrated in the user client 202 may also be implemented using a thin client whereby the functionality of the web browser 204 and the personal recruiting application 206 may be implemented on the job server 216. In such an embodiment, the user client 202 merely acts as an interface for a user to interact with the job server 216.

In various embodiments, a user client 202 may communicate with one or more job servers 216 through a network 214. The user client 202 may be a computer such as computer system 100 of FIG. 1 or another computing device including a mobile device such as a mobile phone. The network 214 may be any type of network such as the Internet, a cellular network, a local area network (LAN), a wide area network (WAN), or other type of network. A web browser 204 may execute on the user client 202 and may include functionality for receiving a request to perform an operation which may be input by a user and functionality for sending the request to a server to perform the operation. The web browser 204 may be operably coupled to a personal recruiting application 206 having functionality for receiving requests to perform an operation for the personal recruiting application 206 and functionality for sending the requests to the job server 216 to perform the requested operation for the personal recruiting application 206. The personal recruiting application 206 may also include functionality for receiving a list of jobs from the personal recruiter application 240 and functionality for sending responses about the job fit for jobs in the job list to the job server 216.

Other applications may also execute on the user client 202 in various embodiments. For example, in embodiments where the user client 202 may be a computing device such as a mobile phone, a personal recruiting application 206 may execute on the mobile phone as a separate component from a web browser 204. The personal recruiting application 206 in this embodiment may have functionality for receiving requests to perform an operation for the personal recruiting application 206 and functionality for sending the requests to the job server 216 to perform the requested operation for the personal recruiting application 206.

In general, the web browser 204 and the personal recruiting application 206 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

A recruiter client 208 may communicate with one or more job servers 216 through network 214 in various embodiments. The recruiter client 208 may be a computer such as computer system 100 of FIG. 1 or another computing device including a mobile device. A web browser 210 may execute on the recruiter client 208 and may include functionality for receiving a request to perform an operation which may be input by a user and functionality for sending the request to a server to perform the operation. The web browser 210 may be operably coupled to a recruiting application 212 having functionality for receiving requests to perform an operation for the recruiting application 212 and functionality for sending the requests to the job server 216 to perform the requested operation for the recruiting application 212. The recruiting application 212 may also include functionality for receiving a list of candidates 274 from the recruiter application 242 and functionality for sending responses to the job server 216 about a candidate's fit for a job from the list of candidates 274. In various embodiments, a user of the recruiter application may be a company recruiter, a curator of candidate lists for job models stored on the job server 216, a tuner of a job model stored on the job server 216, and so forth.

The web browser 210 and the recruiting application 212 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The job server 216 may be any type of computer system or computing device such as computer system 100 of FIG. 1. In general, the job server 216 may support services for modeling jobs, may support data mining career streams of a corpus of candidate profiles, and may support services for matching candidates to a job using job similarity and candidate similarity. In particular, the job server 216 may include a career path compiler 218 that may include functionality for data mining a large corpus of candidate profiles to extract job transitions and construct a collation of career streams and career stream counts. The career path compiler may include a job information parser 220 having functionality to parse elements of a candidate profile and extract information about job transitions such as a job title, job description, employer, service dates, preceding job information, subsequent job information, and so forth. And the career path compiler 218 may include a career stream constructor 222 having functionality to construct a collation of career streams and career stream counts from the information about job transitions extracted from the candidate profiles. The career path compiler 218 may be operably coupled to server storage 258 that may store a large corpus of candidate profiles 260 and a collation of career streams 262 with career stream counts 264 generated by the career path compiler 218 from the large corpus of candidate profiles 260.

The job server 216 may include a job modeler 224 that may include functionality for generating a job model with clustered feature datasets for a job profile and functionality for tuning the job model from feedback about the fit for candidates sourced for the job profile. Accordingly, the job modeler 224 may include a feature clustering engine 226 having functionality for generating clustered feature datasets 272, a job model initializer 228 having functionality for initializing feature weights and clustered feature weights and having functionality for boosting clustered feature weights, and a job model tuner 234 having functionality for tuning the job model weights from feedback about the fit of candidates sourced for the job. In an embodiment, the job model initializer 228 may include a feature weight calculator 230 having functionality for initializing feature weights and clustered feature weights and may include a cluster weight booster 232 having functionality for boosting clustered feature weights. The job model tuner may include in an embodiment a model feedback engine 236 having functionality for receiving responses about the fit of candidates sourced for the job and may include logistic regression calculator 238 having functionality for determining the log loss for logistic regression from the responses about the fit of candidates sourced for the job and updating the weights of the job model. The job modeler 224 may be operably coupled to server storage 258 that may store a corpus of candidate profiles 260 and job models 270 with clustered feature datasets 272 generated by the feature clustering engine 226 from a corpus of candidate profiles 260.

The job server 216 may also include a personal recruiter application 240 and a recruiter application 242 that may each be operably coupled to a database engine 244, a job match engine 248, and server storage 258. The personal recruiter application 240 may be implemented as an online application that includes functionality for interacting with the personal recruiting application 206 executing on a computing device, functionality for receiving a job list from the job match engine 248 and functionality to send a job list to the personal recruiting application 206 for display on a computing device such as user client 202. The recruiter application 242 may be implemented as an online application that includes functionality for interacting with the recruiting application 212 executing on a computing device, functionality for receiving a candidate list from the job match engine 248 and functionality to send a candidate list to the recruiting application 212 for display on a computing device such as recruiter client 208, and functionality for receiving responses from the recruiting application 212 about a candidate's fit for a job from the list of candidates 274.

The job server 216 may also include a job match engine 248 that may be operably coupled to the personal recruiter application 240, the recruiter application 242, a ranking engine 254, the database engine 244 and server storage 258. The job match engine 248 may include functionality in an embodiment for receiving a request to match one or more candidate profile to a job profile, and functionality for sending a list of one of more candidate profiles to a ranking engine 254 to rank the candidate profiles matched to the job profile. In an embodiment, the job match engine 248 may include a job similarity engine 250 having functionality for determining job similarity scores between the job profile and one or more jobs in each of the candidate profiles using career stream counts of career streams and may include a job probability engine 252 having functionality for determining candidate match scores between a job model of the job profile and each of the candidate profile using clustered feature datasets. The job server 216 may also include a ranking engine 254 that may be operably coupled to the job match engine 248, the database engine 254 and server storage 258. The ranking engine 254 may include functionality in an embodiment for receiving a request to rank a list of candidate matches to a job scored by the job match engine 248, and functionality to generate a short list of ranked candidates for the job. In an embodiment, the ranking engine 254 may include a candidate list generator 256 having functionality to generate the short list of candidates matching a job.

The career path compiler 218 and each of its components, the job modeler 224 and each of its components, the personal recruiter application 240, the recruiter application 242, the job match engine 248 and each of its components, the ranking engine 254 and each of its components, the database engine 244 and each of its components may each be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The job server 216 may additionally include a database engine 244 and server storage 258. The database engine 244 may provide database services and may include a query processor 246 having functionality to process received queries by retrieving the data from the server storage 258 and processing the retrieved data. The database engine 244, the job match engine 248, the ranking engine 254, the personal recruiter application 240, the recruiter application 242, the job modeler 224 and the career path compiler 218 may each be operably coupled to server storage 258 that stores information for candidate profiles 260, information for career streams 262 including career stream counts 264, information for job profiles 266, similar job information 268, information for job models 270 including clustered feature datasets 272, and information for candidate lists 274.

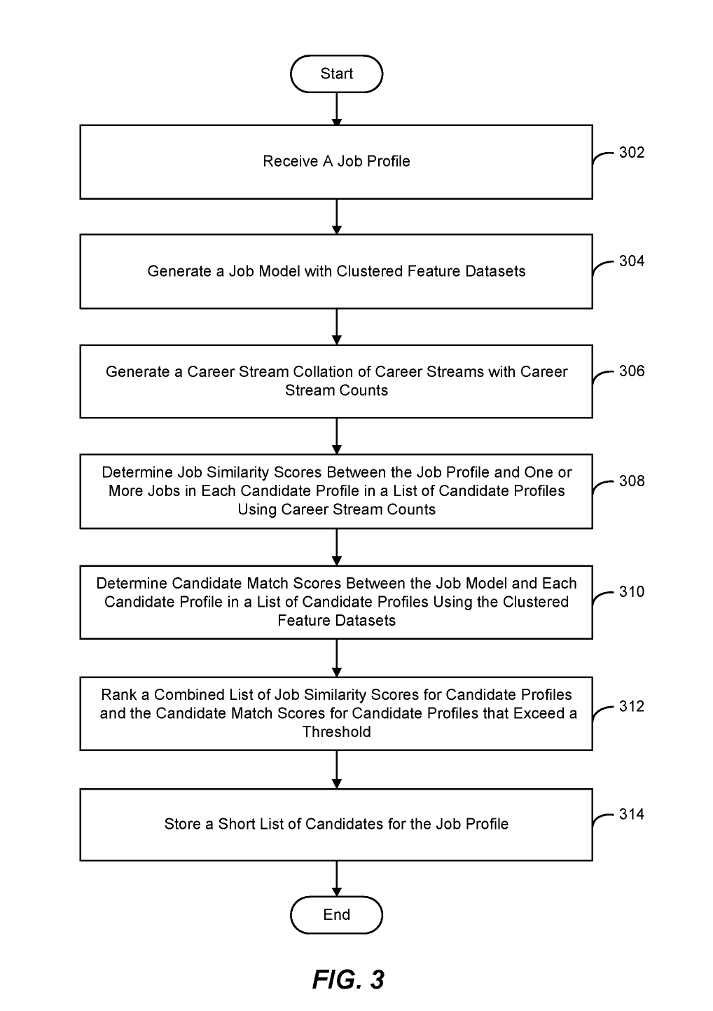

FIG. 3 presents a flowchart generally representing the steps undertaken in one embodiment for matching candidates to a job using job similarity and candidate similarity. At step 302, a job profile may be received for matching candidates to a job. In an embodiment, an online application on the job server such as the recruiter application may receive a request with a job profile from a recruiting application executing on a recruiter client to match candidates to the job profile. The job profile may include information about the job such as the job title, the employer's company name, the job description, and so forth.

At step 304, a job model with clustered feature datasets may be generated for the job profile received. In an embodiment, a corpus of candidate profiles may be selected for generating clustered feature datasets for the job model. In various embodiments, the corpus of candidate profiles may be selected by attributes of the candidate profiles that may closely match attributes of the job profile, such as the job title, education, experience, or other attributes or combination of attributes. The corpus of candidate profiles may be the same list of candidate profiles described in step 306 below or may be a different list of candidate profiles that may include some candidate profiles that occur in the list of candidate profiles described in step 306 below. The job modeler 224 may generate, for instance, the clustered feature datasets for the job model from the corpus of candidate profiles and may initialize weights for the features and clustered feature datasets of the job model.

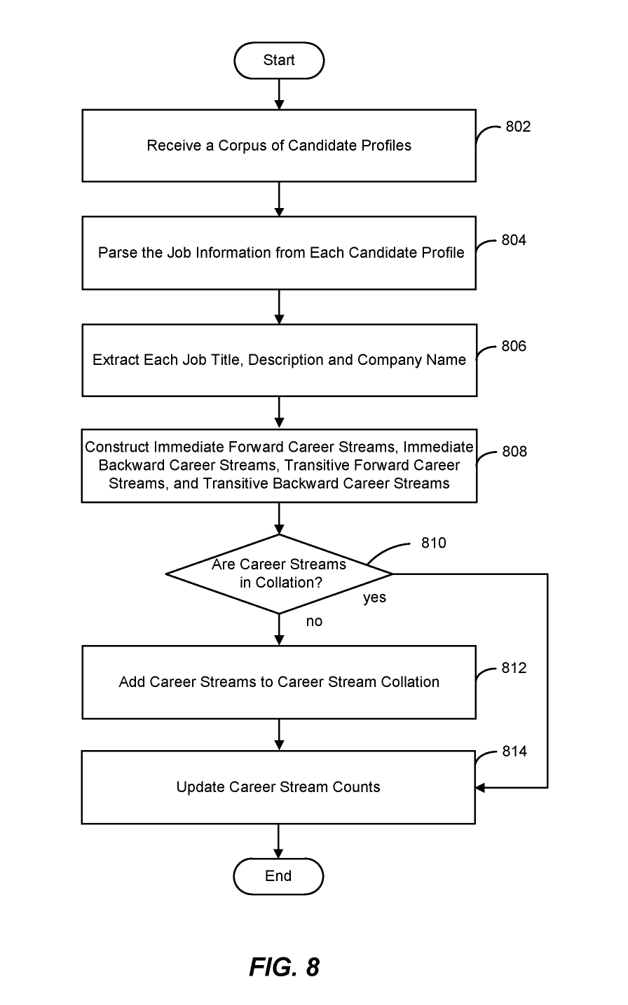

At step 306, a career stream collation of career streams with career stream counts may be generated from a large corpus of candidate profiles. The large corpus of candidate profiles may be the same list of candidate profiles described in step 304 above or may be a different list of candidate profiles that may include some candidate profiles that occur in the list of candidate profiles described in step 304 above. In general, the career streams of each candidate's career path may be extracted from the candidate's job progression history. A career stream as used herein means a career path or a subpath of a career path. For example, consider the job progression history of four jobs titled Analyst Intern, Analyst, Senior Analyst, and Director of Analytics from a candidate's profile. There may be career streams that represent an immediate transition, or single transition, between two job titles such as Analyst and Senior Analyst, and there may also be career streams that represent a transitive transition, or two or more transitions, between two job titles such as Analyst and Director of Analytics. A collation of uniquely identifiable career streams may be generated by the career path compiler 218 from a large corpus of candidate profiles with a count of the number of occurrences of each uniquely identifiable career stream within the large corpus of candidate profiles. Generating a career stream collation of career streams with career stream counts from a large corpus of candidate profiles may be described in further detail below in conjunction with FIG. 8.

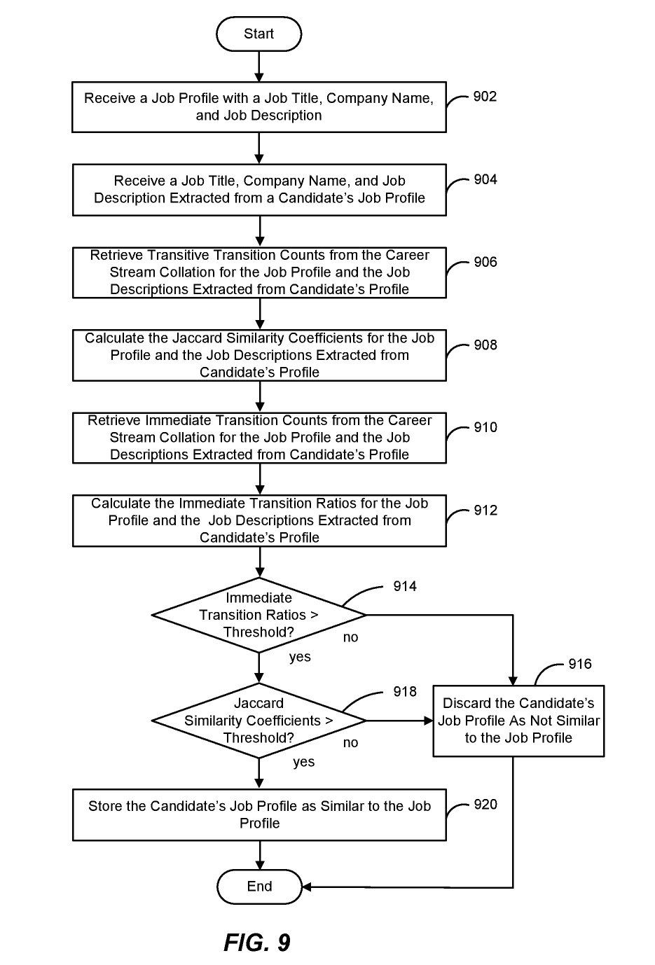

At step 308, job similarity scores may be determined between the job profile and one or more jobs in each candidate profile in a list of candidate profiles using career stream counts of career streams extracted from the large corpus of candidate profiles. The list of candidate profiles may be the same list of candidate profiles from the large corpus of candidate profiles described in step 306 above or may be a different list of candidate profiles that may include some candidate profiles that occur in the large corpus of candidate profiles described in step 306 above. In an embodiment, the job similarity engine 250 may determine job similarity between the job profile and one or more job descriptions extracted from candidate's profile such as the candidate's current job, a job for which candidate was rejected, or a job in which the candidate is interested. In various embodiments, immediate transition and transitive transition counts are retrieved for the job profile and the job descriptions extracted from candidate's profile. Immediate transition ratios may be calculated between the job profile and the job descriptions extracted from candidate's profile to determine whether the candidate's transition to the position of the job profile is a promotion or lateral move. And jaccard similarity coefficients may be calculated between the job profile and the job descriptions extracted from candidate's profile to determine whether the candidate's transition to the position of the job profile is a job transition to a similar job on a career path leading to a higher position. The calculation of the immediate transition ratios and the jaccard similarity coefficients may be described in further detail below in conjunction with FIG. 9. Job similarity scores may be calculated for each candidate profile in the list of candidate profiles by averaging the immediate transition ratios and the jaccard similarity coefficients.

At step 310, candidate match scores may be determined between the job model using the clustered feature datasets and each candidate profile in a list of candidate profiles. The list of candidate profiles may be the same list of candidate profiles in step 308 or may be a different list of candidate profiles that may include some candidate profiles that occur in the list of candidate profiles in step 308. In general, the job probability engine 252 may use a Naïve-Bayes algorithm to determine the probability of a match between the job model with the clustered feature datasets and each candidate profile of a list of candidate profiles selected. The job model may be represented as a vector of features with weighted clustered feature datasets. Each candidate profile may be represented as a vector of the same features determined for the job model. The Naïve-Bayes algorithm may determine the probability of a match between the vector of features of each candidate and the weighted vector of features of the job model to generate a match score as follows: p(C|J)=ŷ=σ(s(C;J)), where the sigmoid function a may be applied to s(C;J)=\vec{w}(J)·\vec{x}(C), where \vec{x}(C) represents a vector of features of a candidate and \vec{w}(J) represents a vector of features with weighted clustered feature datasets of a job model.

At step 312, a combined list of job similarity scores for candidate profiles and candidate match scores for candidate profiles that exceed a threshold may be ranked. The job similarity scores and the candidate match scores may range between −1 and 1. In an embodiment, the ranking engine 254 may rank the list of candidates by job similarity scores generated by the job similarity engine 250 and may rank the list of candidates by candidate match score generated by the job probability engine 252; and the candidate list generator 256 may select a short list of candidates from either list or from a combined list with the highest scores among the job similarity scores and the candidate match scores. And at step 314, a short list of ranked candidates for the job profile may be stored in storage such as server storage 258. The short list of ranked candidates for the job profile may be served in an embodiment to a recruiter client 208, and the recruiter client 208 may provide feedback about fit of candidates on the short list of ranked candidates.

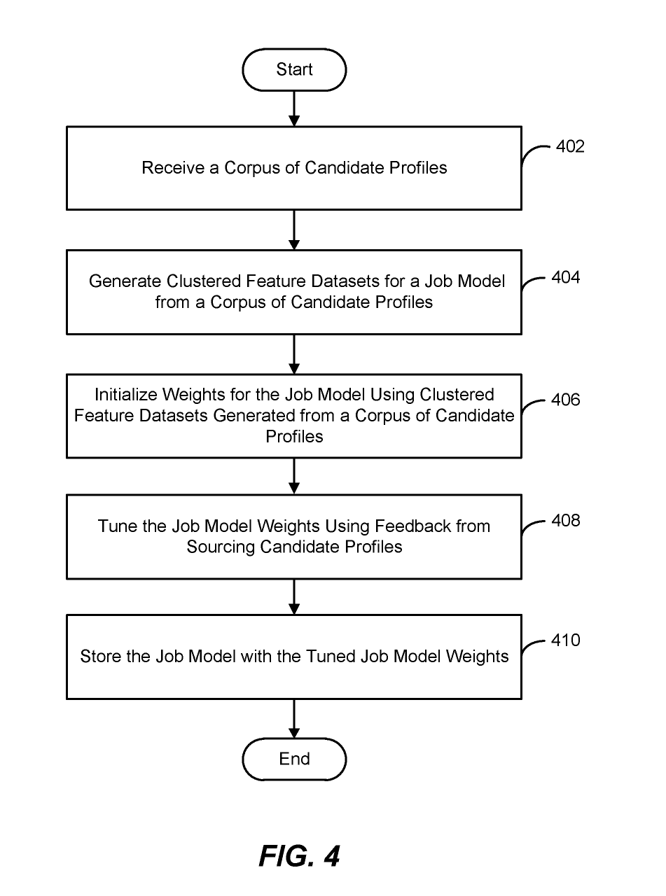

FIG. 4 presents a flowchart generally representing the steps undertaken in one embodiment for generating a job model with clustered feature datasets for a job profile. At step 402, a corpus of candidate profiles may be received. In an embodiment the corpus of candidate profiles may be received by the job modeler 224. In various embodiments, the corpus of candidate profiles may represent attributes of the candidate profiles that may closely match attributes of the job profile, such as the job title, education, experience, or other attributes or combination of attributes.

At step 404, clustered feature datasets may be generated for the job model from the corpus of candidate profiles. In an embodiment, clustered feature datasets may be generated for a functional area, industry, school rank, and so forth. For example, job title clustering may discover broad job categories associated with a job title such as the job categories management and sales associated with a job title of sales manager. And company clustering may discover an industry and size associated with a company such as the retail industry associated with a company such as Nordstrom. As another example, school clustering may discover a school rank associated with an educational degree.

At step 406, job model weights may be initialized for the job model using clustered feature datasets generated from the corpus of candidate profiles. In an embodiment, log-odds weights may be generated for features and clustered feature datasets of the job model, and a manual boost of the clustered feature datasets may be received. An elementwise product of the log-odds weights for the features and the manual boost weights of the clustered features for each corresponding feature may be performed to determine weights for the features of the job model.

At step 408, the job model weights may be tuned using feedback from sourcing candidate profiles for the job represented by the job model. For example, a user of the recruiter client 208 may provide feedback about fit of candidates on a short list of ranked candidates received for the job represented by the job model. In another embodiment, a candidate may receive the job on a short list of jobs matched for the candidate, and the candidate may provide feedback about fit of the job represented by the job model. The weights of the job model may be tuned in various embodiments by optimizing the log loss for logistic regression based upon the responses received about job fit.

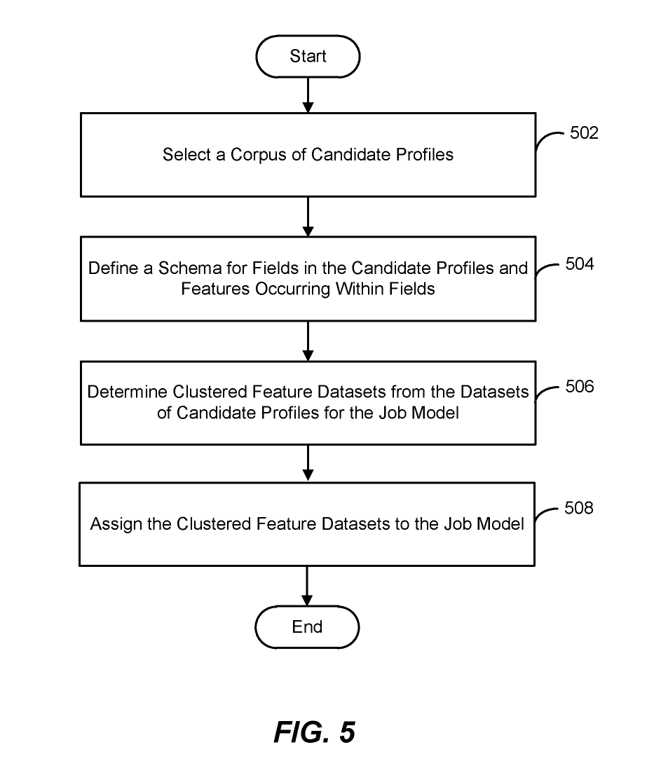

FIG. 5 presents a flowchart generally representing the steps undertaken in an embodiment for generating clustered feature datasets for the job model from the corpus of candidate profiles. In an embodiment, the feature clustering engine 226 may generate clustered feature datasets by performing semantic clustering for various elements of candidate profiles from a corpus of candidate profiles. At step 502, a corpus of candidate profiles may be received. In an embodiment, the corpus of candidate profiles may represent an entire database on the order of 100 million candidate profiles. Each candidate profile may have many fields, and each field may have specific terms that may represent features. For example, a candidate profile may have a field such as “school” and the field “school” may include the feature “Stanford”. At step 504, a data schema may be defined for fields of the candidate profile and features that occur within fields. A candidate profile vector of features ordered by the data schema may then be generated. And this vector of features ordered by the data schema may be used to construct a vector of features for the job model.

At step 506, clustered feature datasets may be determined for the job model from the corpus of candidate profiles. In an embodiment, job title clustering may be performed to discover broad job categories associated with a job title. A clustered feature which may be labeled “functional area” may be added to the data schema and the broad job categories may be added as features to the vector. Company clustering may be performed to discover an industry and size associated with a company. A clustered feature which may be labeled “industry” may be added to the data schema and the industry categories may be added as features to the vector. School clustering may be performed to discover a school rank associated with a school and the rank categories may be added as features to the vector.

At step 508, the clustered feature datasets may be assigned to the job model. In an embodiment, a vector of features ordered by the data schema that includes the features of clustered feature datasets determined from the corpus of candidate profiles may be used to construct a vector of features for the job model. And this vector of features that includes the features of clustered datasets may be stored, for instance, as job model 270 with clustered features 272 in server storage 258 of FIG. 2.

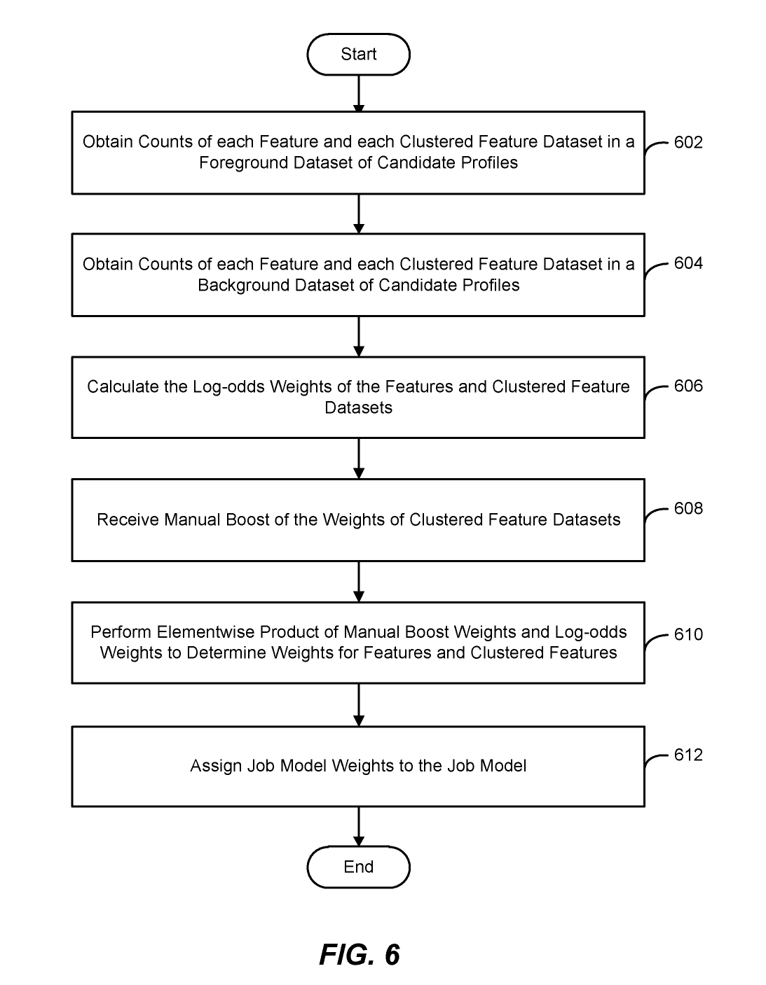

FIG. 6 presents a flowchart generally representing the steps undertaken in an embodiment for initializing job model weights for the job model with clustered feature datasets generated from the corpus of candidate profiles. In an embodiment, the feature weight calculator 230 may initialize weights for the vector of features of the job model. At step 602, counts of each feature for the vector of features of the job model may be obtained from a foreground dataset of candidate profiles. In an embodiment, 1,000 to 10,000 candidate profiles that most closely match the job may be selected for the foreground dataset. And, at step 604, counts of each feature for the vector of features of the job model may be obtained from a background dataset of candidate profiles. The background dataset of candidate profiles may include the foreground dataset of candidate profiles. In an embodiment, the foreground dataset of candidate profiles may represent an entire database on the order of 100 million candidate profiles.

At step 606, log-odds weights may be calculated for the counts of features of the vector of the job model occurring within the foreground dataset of candidate profiles and counts of features of the vector of the job model occurring within the background dataset of candidate profiles. In various embodiments, the term frequency-inverse document frequency weight may be calculated and used as a weight for the features of the vector of the job model. At step 608, a manual boost of the clustered feature datasets may be received. In an embodiment, the cluster weight booster 232 may receive a booster weight for boosting clustered feature weights. A curator for the job model may enter manual booster weights for fields with clustered feature datasets to balance any overrepresentation by the number of features occurring in the field from the corpus of candidate profiles.

At step 610, an elementwise product of the log-odds weights for the features and the manual boost weights of the clustered features corresponding to the respective features may be performed to determine weights for the features of the job model. And at step 612, the job model weights may be assigned to the job model. And the job model weights for the vector of features that includes the features of clustered datasets may be stored, for instance, as job model 270 with clustered features 272 in server storage 258 of FIG. 2.

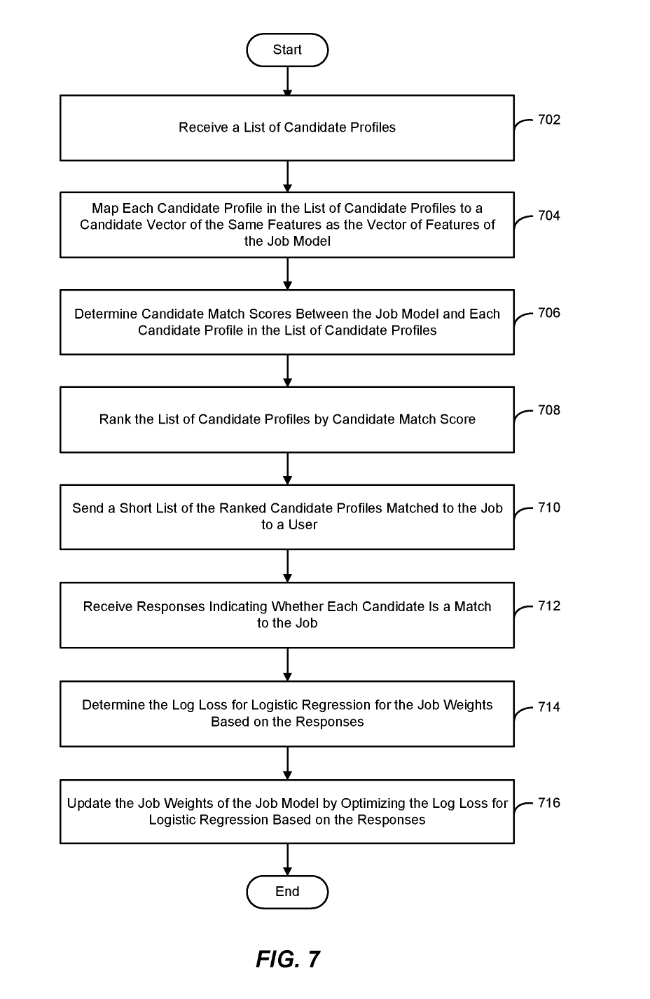

FIG. 7 presents a flowchart generally representing the steps undertaken in an embodiment for tuning the job model weights for the job model with clustered feature datasets using feedback from sourcing candidate profiles for the job represented by the job model. In an embodiment, the job model tuner 234 may receive feedback about job fit for candidates and tune the job model weights for the vector of features of the job model by optimizing the log loss for logistic regression based upon the responses received about job fit. At step 702, a list of candidate profiles may be received. And at step 704, each candidate profile may be mapped to a candidate vector of the same features with weighted clustered feature datasets as the vector of features of the job model. In an embodiment, this candidate vector may be a binary vector representing which features are present and absent in the candidate profile. In various embodiments, a bias feature may be added to the candidate vector that may be set to the value of 1 to allow for different weight schemes that may center scores differently. For example, the term frequency-inverse document frequency weight may be positive when used as initial weights and consequently result in probabilities that are greater than 0.5. The bias feature may be used to alleviate this.

At step 706, match scores between the job model and each candidate profile in the list of candidate profiles may be determined. In an embodiment, the job probability engine 252 may use a Naïve-Bayes algorithm to determine the probability of a match between the job model with the clustered feature datasets and each candidate profile of a list of candidate profiles selected. The Naïve-Bayes algorithm may determine the probability of a match between the vector of features of each candidate and the weighted vector of features of the job model to generate a match score as follows: p(C|J)=ŷ=σ(s(C;J)), where the sigmoid function σ may be applied to s(C;J)=\vec{w}(J). \vec{x}(C), where \vec{x}(C) represents a vector of features of a candidate and \vec{w}(J) represents a vector of features with weighted clustered feature datasets of a job model.

At step 708, the list of candidate profiles may be ranked by candidate match score. In an embodiment, the ranking engine 254 may rank the list of candidates by candidate match score generated by the job probability engine 252. And at step 710, a short list of candidate profiles matched to the job model may be sent to a user. The candidate list generator 256 may select a short list of ranked candidates matched to the job model, and the short list of ranked candidates matched to the job model may be served in an embodiment by the recruiter application 242 to a recruiter client 208, and the recruiter client 208 may provide feedback about fit of candidates on the short list of ranked candidates.

At step 712, responses indicating whether each candidate is a match to the job may be received. In an embodiment, the model feedback engine 236 may receive responses providing feedback about the fit of candidates on a short list of ranked candidates. In an embodiment, the responses about the fit of a particular candidate may be a label indicating either a fit or not a fit. At step 714, the log loss for logistic regression may be determined for the job model weights based upon the responses. In an embodiment, logistic regression calculator 238 may determine the log loss for logistic regression from the responses about the fit of candidates sourced for the job and may update the weights of the job model. And at step 716, the weights of the job model may be updated by optimizing the log loss for logistic regression based on the responses. In various embodiments, the cross-entropy loss may be optimized by using stochastic gradient decent algorithms, adaptive stochastic gradient decent algorithms such as AdaGrad, or stochastic gradient decent algorithms with adaptive moment estimation such as Adam.

FIG. 8 presents a flowchart generally representing the steps undertaken in an embodiment for generating a career stream collation of career streams with career stream counts from a large corpus of candidate profiles. In an embodiment, the career path compiler 218 may extract job histories from a large corpus of candidate profiles and construct uniquely identifiable career streams with a count of the number of occurrences of each uniquely identifiable career stream within the large corpus of candidate profiles. At step 802, a corpus of candidate profiles may be received, and the job information may be parsed at step 804 from each candidate profile. Job information may include a job title, job description, employer, service dates, preceding job information, subsequent job information, and so forth. And at step 806, each job title, job description and company name may be extracted from each candidate profile. Those skilled in the art will appreciate that the extraction of the job information may occur during the parsing of the candidate profile in various embodiments.

At step 806, immediate forward transition career streams, immediate backward transition career streams, transitive forward transition career streams, and transitive backward transition career streams may be constructed. For example, consider the job progression history of four jobs titled Analyst Intern, Analyst, Senior Analyst, and Director of Analytics from a candidate's profile. There may be six career streams identifiable from this job progression history that may be represented by the following tuples: (Analyst Intern, Analyst), (Analyst Intern, Senior Analyst), (Analyst Intern, Director of Analytics), (Analyst, Senior Analyst), (Analyst, Director of Analytics), (Senior Analyst, Director of Analytics). There may be career streams that represent an immediate transition, or single transition, between two job titles such as Analyst and Senior Analyst, and there may also be career streams that represent a transitive transition, or two or more transitions, between two job titles such as Analyst and Director of Analytics. Each immediate transition in a career path such as Analyst and Senior Analyst may be denoted as an immediate forward transition, and the backward transition of an immediate forward transition may be denoted as an immediate backward transition such as Senior Analyst and Analyst. Similarly, each transitive transition in a career path such as Analyst and Director of Analytics may be denoted as a transitive forward transition, and the backward transition of a transitive forward transition may be denoted as a transitive backward transition such as Director of Analytics and Analyst. In various embodiments, the collation of uniquely identifiable career streams with career stream counts may be constructed, stored and accessed using one of more data structures that support insertion of new career stream information and updating of existing career stream information including a data dictionary, a binary search tree, a hash table or other suitable data structure. For example, the career stream information may be represented in an embodiment in two data dictionaries, a data dictionary that stores forward career stream information, such as immediate forward transition career streams and transitive forward transition career streams, and another data dictionary that stores backward career stream information, such as immediate backward transition career streams and transitive backward transition career streams. In an embodiment, the career stream information may be represented by a tuple of titles and a count such as (Analyst, Senior Analyst), 883,527. In yet another embodiment, the employer's company name may be included with a title such that the career stream information may be represented by a tuple of titles with company name and a count such as ((Analyst, IBM), (Senior Analyst, IBM)), 23,641.

At step 810, it may be determined whether each constructed career stream occurs within the collation of career streams. If it may be determined that a career stream occurs within the collation of career streams, then the career stream count for the career stream may be updated at step 814. Otherwise, if it may be determined that the career stream does not occur within the collation of career streams, the career stream may be added to the career stream collation at step 812 and the career stream count for the career stream may be updated at step 814. A career stream collation may accordingly be constructed from a corpus of candidate profiles.

FIG. 9 presents a flowchart generally representing the steps undertaken in an embodiment for calculating the immediate transition ratios and the jaccard similarity coefficients between two work experiences to determine job similarity of two jobs that may have different titles. In an embodiment, the job similarity engine 250 may determine job similarity between the job profile and one or more job descriptions extracted from candidate's profile by calculating the immediate transition ratios and the jaccard similarity coefficients. At step 902, a job profile with a job title, a job description and a company name may be received. The job profile may include information about the job such as the job title, the employer's company name, the job description, and so forth. And at step 904, a job title, a company name and a job description that may be extracted from a candidate profile may be received. In an embodiment, there may be one or more job descriptions extracted from a candidate profile.

At step 906, transitive transition counts may be retrieved from the collation of career streams for job information of the job profile and for the job descriptions extracted from a candidate profile. In an embodiment, transitive transition forward counts for the job profile and for the job descriptions extracted from a candidate profile may be retrieved from a data dictionary that stores forward career stream information. And transitive transition backward counts for the job profile and for the job descriptions extracted from a candidate profile may be retrieved from a data dictionary that stores backward career stream information. Consider, for example, whether a job profile with a job title of Analyst Intern and a job description extracted from a candidate profile with the job title of Data Science Intern may be similar jobs. A search of the career stream collation may return career streams of career transition paths from a position of Analyst Intern and Data Science Intern that lead to the same higher position. For instance, the following career streams with transitive transition forward counts for a career transition path from Analyst Intern to a higher position such as Director of Data Science may be retrieved in an embodiment: ((Analyst Intern, Analyst), 5), ((Analyst, Senior Analyst), 3), and ((Senior Analyst, Director of Data Science), 2). And the following career streams with transitive transition forward counts for a career transition path from Data Science Intern to a higher position such as Director of Data Science may be retrieved in an embodiment: ((Data Science Intern, Data Science Analyst), 9), ((Data Science Analyst, Senior Data Science Analyst), 7), and ((Senior Data Science Analyst, Director of Data Science), 5).

At step 908, the jaccard similarity coefficients may be calculated for the job profile and for the job descriptions extracted from a candidate profile. Jaccard similarity coefficients may be calculated between the job profile and the job descriptions extracted from candidate's profile to determine whether the candidate's transition to the position of the job profile is a job transition to a similar job on a career path leading to a higher position.

In an embodiment the Jaccard similarity coefficient tsf(j1,j2) may be calculated between the job profile's job information of job title, company name, and job description, (j1), and the candidate's job information of job title, company name, and job description, (j2), using transitive forward transition counts. And the Jaccard similarity coefficient tsb(j2,j1) may be calculated in an embodiment between the candidate's job information of job title, company name, and job description, (j2), and the job profile's job information of job title, company name, and job description, (j1), using transitive backward transition counts. Returning to the example above of the following career streams with transitive transition forward counts for a career transition path from Analyst Intern to a higher position such as Director of Data Science, ((Analyst Intern, Analyst), 5), ((Analyst, Senior Analyst), 3), and ((Senior Analyst, Director of Data Science), 2), and the following career streams with transitive transition forward counts for a career transition path from Data Science Intern to a higher position such as Director of Data Science, ((Data Science Intern, Data Science Analyst), 9), ((Data Science Analyst, Senior Data Science Analyst), 7), and ((Senior Data Science Analyst, Director of Data Science), 5), the jaccard similarity coefficient tsf(j1,j2) may be calculated as 3/(20+21)−3=0.079.

At step 910, immediate transition counts may be retrieved from the collation of career streams for job information of the job profile and for the job descriptions extracted from a candidate profile. In an embodiment, immediate transition forward counts for the job profile and for the job descriptions extracted from a candidate profile may be retrieved from a data dictionary that stores forward career stream information. And immediate transition backward counts for the job profile and for the job descriptions extracted from a candidate profile may be retrieved from a data dictionary that stores backward career stream information.

At step 912, the immediate transition ratios may be calculated for the job profile and for the job descriptions extracted from a candidate profile. Immediate transition ratios may be calculated between the job profile and the job descriptions extracted from candidate's profile to determine whether the candidate's transition to the position of the job profile is a job transition to a similar job on a career path leading to a higher position. In an embodiment, the immediate transition ratio imtr(j1,j2) may be calculated between the job profile's job information of job title, company name, and job description, (j1), and the candidate's job information of job title, company name, and job description, (j2), using immediate forward transition counts and immediate backward transition counts by the equation imtr(j1,j2)=imft(J1,J2)/imbt(j1,j2). And, in an embodiment, the immediate transition ratio imtr(j2,j1) may be calculated between the candidate's job information of job title, company name, and job description, (j2), and the job profile's job information of job title, company name, and job description, (j1), using immediate forward transition counts and immediate backward transition counts by the equation imtr(j2,j1)=imft(J2,J1)/imbt(j2,j1).

At step 914, it may be determined whether the immediate transition ratios exceed a threshold. In an embodiment, it may be determined whether the immediate transition ratio imtr(j1,j2) may exceed the threshold of 0.6, such that imtr(j1,j2)>0.6, and it may also be determined whether the immediate transition ratio imtr(j2,j1) may exceed the threshold of 0.6, such that imtr(j2,j1)>0.6. Those skilled in the art will appreciate that the threshold may indicates a lateral transition instead of a promotion and other threshold values may be used such as a threshold greater than 0.5 or two different threshold values may be used. If it may be determined that the immediate transition ratios do not exceed a threshold, then the candidate's profile may be discarded as not similar to the job profile at step 916.

If it may be determined that the immediate transition ratios exceed a threshold, then it may be determined at step 918 whether the jaccard similarity coefficients exceed a threshold. In an embodiment, it may be determined whether the jaccard similarity coefficient tsf(j1,j2) may exceed the threshold of 0.7, such that tsf(j1,j2)>0.7, and it may also be determined whether the jaccard similarity coefficient tsb(j2,j1) may exceed the threshold of 0.7, such that tsb(j2,j1)>0.7. Those skilled in the art will appreciate that other threshold values may be used such as a threshold greater than 0.5 or two different threshold values may be used. Those skilled in the art will further appreciate that a combined threshold such as adding the scores tsf(j1,j2) and tsf(j1,j2) may also be used in an embodiment. If it may be determined that the jaccard similarity coefficients do not exceed a threshold, then the candidate's profile may be discarded as not similar to the job profile at step 916. Otherwise, the candidate's profile and similarity score may be stored as similar to the job profile at step 920.

Thus, job similarity scores may be determined between the job profile and one or more jobs in each candidate profile in a list of candidate profiles using career stream counts of career streams extracted from the large corpus of candidate profiles. By data mining a large corpus of candidate profiles to discover transitive steps between two work experiences, candidates may be sourced for an open position where the job transition from their current position to the open position may be a promotion or lateral move and where the job may be similar to a job leading toward the career objective of the candidate.

As can be seen from the foregoing detailed description, a system and method is disclosed in various embodiments that are generally directed to matching candidates to a job using job similarity and candidate similarity. More particularly, the system and method disclosed may support services for modeling jobs, may support data mining career streams of a corpus of candidate profiles, and may support services for matching candidates to a job using job similarity and candidate similarity. Importantly, the system and method may leverage candidate similarity to build a job model with clustered features, initialize the job model by boosting weights for clustered feature datasets, and iteratively tune the job model using feedback about the fit of candidates to the job model. Moreover, a collation of uniquely identifiable career streams may be generated from a large corpus of candidate profiles with a count of the number of occurrences of each uniquely identifiable career stream within the large corpus of candidate profiles. Advantageously, the system and method may leverage this collation of career streams to identify whether the candidate's transition to the position of the job profile is a promotion or lateral move and whether the candidate's transition to the position of the job profile is a job transition to a similar job on a career path leading to the candidate's career objective. As a result, the system and method provide significant advantages and benefits needed in contemporary computing and in online recruiting applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for generating a collation of job transitions, comprising:
a processor;
a career path compiler operably coupled to the processor that performs data mining of a plurality of candidate profiles to extract a plurality of job transitions and construct a collation of a plurality of career streams, each of the plurality of career streams having a career stream count;
a job information parser operably coupled to the career path compiler that parses a plurality of elements of the plurality of candidate profiles and extracts information about the plurality of job transitions including at least a job title;
a career stream constructor operably coupled to the career path compiler that constructs the collation of the plurality of career streams, each of the plurality of career streams having the career stream count, from the information about the job transitions; and
a server storage operably coupled to the career path compiler that stores the collation of the plurality of career streams, each of the plurality of career streams having the career stream count.

2. A computer system for sourcing candidates for a job, comprising:
a processor;
a job match engine operably coupled to the processor that receives a request to match a plurality of candidate profiles to a job profile;
a job similarity engine operably coupled to the job match engine that determines a plurality of job similarity scores between the job profile and one or more jobs in each of the plurality of candidate profiles using a plurality of career stream counts of a plurality of career streams;
a ranking engine operably coupled to the job match engine that receives a request to rank a list of the plurality of candidate profiles by the plurality of job similarity scores between the job profile and the one or more jobs in each of the plurality of candidate profiles; and
a server storage operably coupled to the ranking engine that stores the list of the plurality of candidate profiles ranked by the plurality of job similarity scores between the job profile and the one or more jobs in each of the plurality of candidate profiles.

3. A computer-implemented method performed by a processor for generating a collation of job transitions, comprising:
receiving a plurality of candidate profiles;
extracting a plurality of job transitions with job information including at least a job title from the plurality of candidate profiles;
constructing a plurality of uniquely identifiable career streams from the plurality of job transitions with the job information, each uniquely identifiable career stream having a count of a number of occurrences of the uniquely identifiable career stream within the plurality of candidate profiles; and
storing the plurality of uniquely identifiable career streams in a collation in persistent storage.

4. The method of claim 3 wherein constructing the plurality of uniquely identifiable career streams from the plurality of job transitions with the job information comprises constructing a plurality of uniquely identifiable immediate career streams from the plurality of job transitions with the job information, each uniquely identifiable immediate career stream representing a single job transition between a job and the next job of the plurality of job transitions.

5. The method of claim 3 wherein constructing the plurality of uniquely identifiable career streams from the plurality of job transitions with the job information comprises constructing a plurality of uniquely identifiable transitive career streams from the plurality of job transitions with the job information, each uniquely identifiable transitive career stream representing two or more job transitions between consecutive jobs of the plurality of job transitions.

6. A computer-implemented method performed by a processor for determining job similarity, comprising:
receiving a job profile with job information including at least a first job title;
receiving candidate job information including at least a second job title extracted from a candidate profile;
retrieving a first plurality of career stream counts that include the first job title from a collation of a plurality of career streams;
retrieving a second plurality of career stream counts that include the second job title from the collation of the plurality of career streams;
determining job similarity scores between the first job title and the second job title from the first plurality of career stream counts that include the first job title and the second plurality of career stream counts that include the second job title; and
storing the second job title as similar to the first job title in persistent storage.

7. The method of claim 6 wherein determining job similarity scores between the first job title and the second job title from the first plurality of career stream counts that include the first job title and the second plurality of career stream counts that include the second job title comprises calculating a jaccard similarity coefficient using at least one first transitive transition count from the first plurality of career stream counts and at least one second transitive transition count from the second plurality of career stream counts.

8. The method of claim 6 wherein determining job similarity scores between the first job title and the second job title from the first plurality of career stream counts that include the first job title and the second plurality of career stream counts that include the second job title comprises calculating an immediate transition ratio using at least one first immediate transition count from the first plurality of career stream counts and at least one second immediate transition count from the second plurality of career stream counts.

9. The method of claim 6 further comprising ranking the candidate profile among a list of a plurality of candidate profiles by a plurality of job similarity scores including the job similarity score between the first job title job and the at least second job title extracted from the candidate profile.

10. The method of claim 9 further comprising outputting a short list of the plurality of candidate profiles ranked by the plurality of job similarity scores.
